(19) United States
(12) Patent Application Publication
(10) Pub. No.: US 2007/0220766 A1
(43) Pub. Date: Sep. 27, 2007

(54) TOOL FOR FINDING AND TRANSFERRING ANGLES

(76) Inventor: Marvin Roy Cooke, Hurricane, UT (US)

Correspondence Address: RANDALL B. BATEMAN;BATEMAN IP LAW GROUP, 8 EAST BROADWAY, SUITE 550, PO BOX 1319, SALT LAKE CITY, UT, 84110, US

(21) Appl. No.: 11/689,420

(22) Filed: Mar. 21, 2007

Related U.S. Application Data
(60) Provisional application No. 60/767,395, filed on Mar. 24, 2006.

(51) Int. Cl. B43L 7/10

(52) U.S. Cl. 33/456

(57) ABSTRACT

A tool may be easily used to determine the size and shape of an opening and transfer these dimensions to a piece of material which is to be cut to fill the opening. The tool is particularly suited to fitting tile around walls, doors, and the like and for then marking the tile for cutting. The tool allows for quick and accurate marking of the tile or other material in order to then cut the material.

### RELATED APPLICATIONS

The present application claims the benefit of U.S. Provisional Application Ser. No. 60/767,395, filed Mar. 24, 2006, which is expressly incorporated herein.

### BACKGROUND OF THE INVENTION

1. The Field of the Invention

The present invention relates to a tool for finding and transferring angles. The present invention is a tool for use in measuring and marking mosaic pieces for cutting, such as in installing tile, flooring, and the like. The tool may be used to quickly and easily determine the necessary angles and size for cutting a piece of material where one or more edges of the material must be cut to conform to a wall, fit an opening, or fit around some obstacle.

2. State of the Art

It is often necessary to cut materials to fit an enclosed or otherwise predetermined space. An example of this is found in installing tile. The tiles around the edges of a room must be cut to fit between the uncut tiles in the center of the room and the walls. These edge tiles must be cut to compensate for irregularities and curvature in the walls, corners which are not square, irregularities in the center tiles, etc. Fitting and cutting these edge tiles is often the most time consuming part of installing tile, as each tile must be individually fit. It is often difficult to accurately measure or estimate the size of the necessary piece of tile as well as the angles which need to be cut in the tile. If a tile is cut too large, the tile must be fitted and cut again, wasting time. If a tile is cut too small, the tile may be unusable, resulting in additional time to fit and cut another tile, as well as lost material.

Cutting a tile or other material may be relatively easy where the tile is being fitted to a flat wall and where the tiles run parallel to the wall. Cuts, however, become increasingly more difficult where the tiles are set at an angle to the wall or where the tiles must be cut to a more complex shape, such as fitting a tile around a corner or door. This difficulty arises in various different situations where a person must fit a piece of material into a particularly sized opening, such as in creating a mosaic, creating wood inlays, etc. In these situations it is desirable to have a tool which allows a person to quickly and accurately measure the size of the opening and transfer these measurements to the material which is to be placed in the opening.

### SUMMARY OF THE INVENTION

It is an object of the present invention to provide an improved tool for determining the correct size and shape for cutting tiles or other materials to fit a predetermined space

According to one aspect of the invention, a tool is provided with a base which may be placed against part of an opening, such as where an uncut edge of a tile will be placed. The tool has movable arms which may then be positioned where the cut edges of the tile will be, effectively determining the size and shape of the tile which needs to be cut. The tool may include a ledge or the like formed in the base to account for grout or the like.

These and other aspects of the present invention are realized in a tool for finding and transferring angles as shown and described in the following figures and related description.

### BRIEF DESCRIPTION OF THE DRAWINGS

Various embodiments of the present invention are shown and described in reference to the numbered drawings wherein:

FIG. 1 shows a top view of the tool of the present invention;

FIG. 2 shows a side view of a joint of the tool of FIG. 1;

FIG. 3A shows a side view of the base of the tool of FIG. 1;

FIG. 3B shows another side view of the base of the tool of FIG. 1;

FIG. 3C shows another side view of the base of the tool of FIG. 1

FIG. 4 shows another side view of the base of the tool of FIG. 1;

FIG. 5 shows a top view of the tool of FIG. 1;

FIG. 6 shows a top view of the tool of FIG. 1;

FIG. 7 shows a top view of the tool of FIG. 1; and

FIG. 8 shows a top view of the tool of FIG. 1.

It will be appreciated that the drawings are illustrative and not limiting of the scope of the invention which is defined by the appended claims. The embodiments shown accomplish various aspects and objects of the invention. It is appreciated that it is not possible to clearly show each element and aspect of the invention in a single figure, and as such, multiple figures are presented to separately illustrate the various details of the invention in greater clarity. Similarly, not every embodiment need accomplish all advantages of the present invention.

### DETAILED DESCRIPTION

The invention and accompanying drawings will now be discussed in reference to the numerals provided therein so as to enable one skilled in the art to practice the present invention. The drawings and descriptions are exemplary of various aspects of the invention and are not intended to narrow the scope of the appended claims.

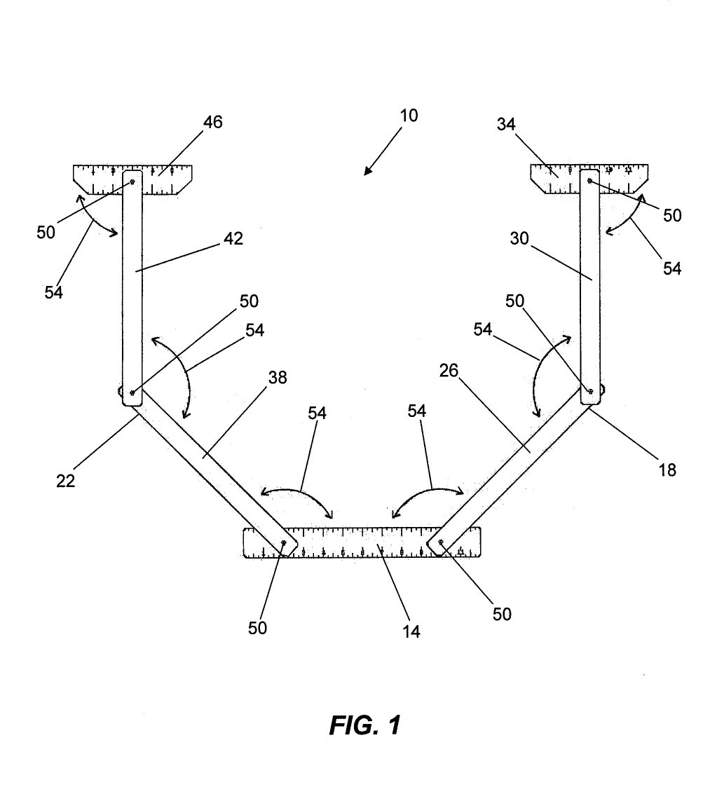

Turning now to FIG. 1, a top view of the tool of the present invention is shown. The tool 10 includes a base 14 which has a first arm 18 and a second arm 22 attached thereto. The first arm 18 includes a first arm section 26 and a second arm section 30. The first arm section 26 is attached to the base 14 and the second arm section 30. The second arm section 30 is also attached to a first indicator member 34. Similarly, the second arm 22 includes a first arm section 38, a second arm section 42, and a second indicator member 46. The base 14, arm sections 26, 30, 38, 42, and indicator members 34, 46 are all joined at joints 50 so as to movable as shown by arrows 54. The joints 50 utilize some frictional resistance to movement such that a moderate force must be applied in order to move arms 18, 22 and indicator members 34, 46.

As shown, the base 14 and indicator members 34, 46 may be marked with ruled edges. This may aid in aligning and using the tool 10, or may simply provide an easily accessible ruler. According to a current embodiment, the base is about twelve inches long, the arm sections 26, 30, 38, 42 are about twelve inches long, and the indicator members 34, 46 are about six inches long. While this size is appropriate for most uses of the tool 10, these dimensions may be altered somewhat as is desired.

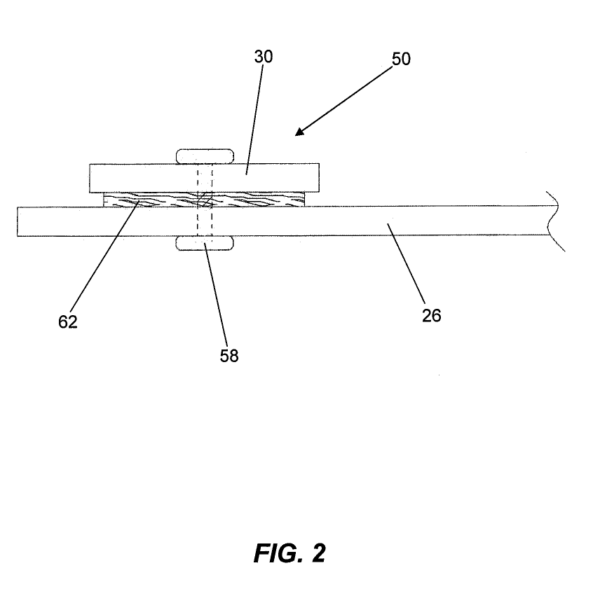

Turning now to FIG. 2, a side view of a joint 50 is shown. The joint 50 is shown between arm section 26 and arm section 30, but would typically be the same for all joints. The joint 50 includes a pivot 58, such as a pin, rivet, bolt, etc. The pivot 58 applies some clamping pressure to the arm sections 26, 30 to generate a small amount of friction between the arm sections. To aid in creating some friction in the joint 50, an intermediate structure 62 such as a thin rubber washer or spring washer or both may be used. A rubber washer would typically be placed between the arm sections 26, 30. A spring washer may be placed between the arm section 26, 30 or may be placed between one of the arm sections and the head of the pivot 58. While two arm sections are shown for each arm, it is appreciated that the arms may include more than two arm sections to facilitate measuring and marking around obstacles.

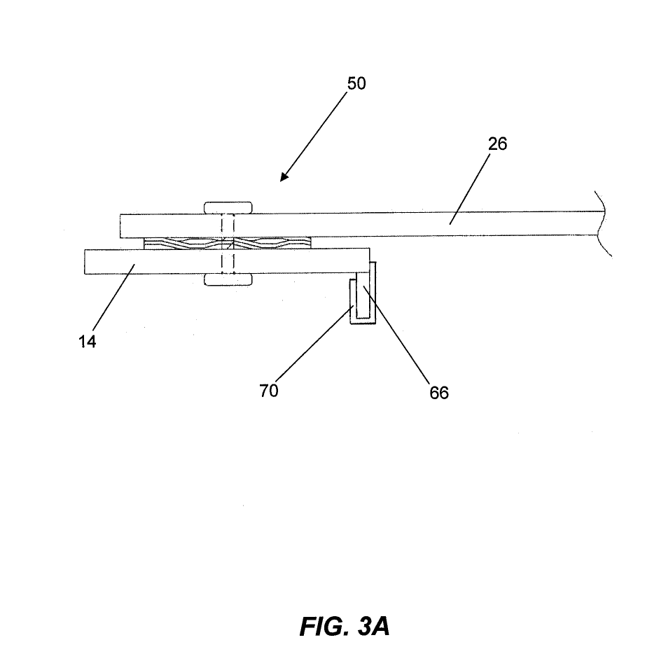

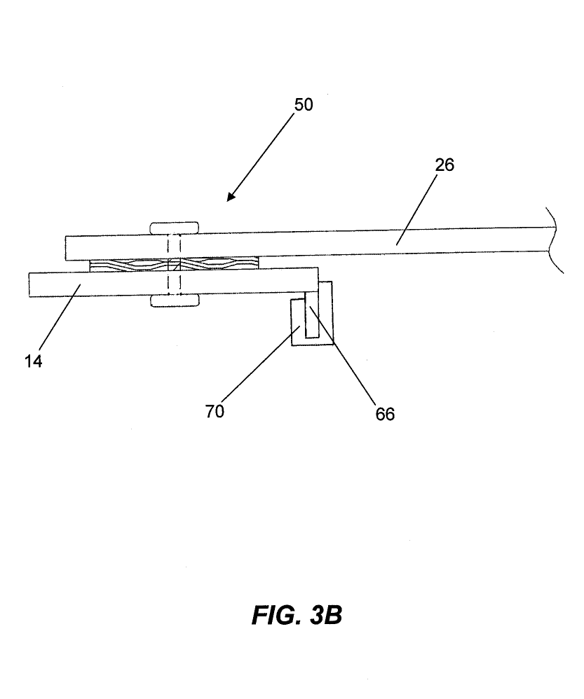

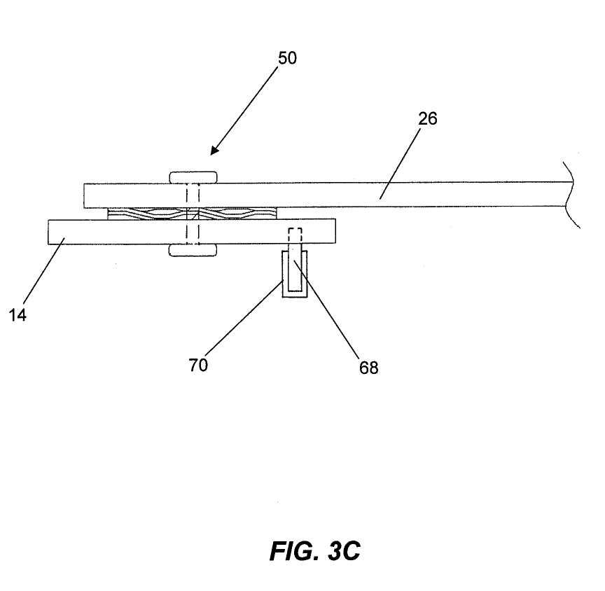

Turning now to FIG. 3A, an end view of the base 14 is shown. It can bee seen how the pivot joint 50 is similar to that shown in FIG. 2. The base 14 is shown with a flange 66. The flange 66 is used to locate the base while using the tool 10. The flange is particularly suited to installing tile as will be further described. The flange 66 may fit in the grout lines of installed tile, and as such is typically made with a thickness matching a common grout thickness. A spacer 70 may be placed over the flange 66 to increase the thickness of the flange to accommodate different thicknesses of grout lines. For example, the flange 66 may be made ⅛ inch thick and spacers 70 may be provided to bring the thickness of the flange to 3/16, ¼, ⅜ inch. FIG. 3B shows how a different size of spacer 70 may be used to vary the effective thickness of the flange 66 to accommodate different thicknesses of grout lines, or to accommodate a different amount of space between the installed pieces of material.

Alternatively, pins may extend downwardly from the base 14 instead of a flange. FIG. 3C shows how pins 68 may extend from the base 14. The pins 68 may be removable when not needed (such as when no grout line is used) and may be adjustable in size or provided with spacers 70 to increase the effective size of the pin 68, or the pins 68 may be provided in a number of different sizes and be interchangeable according to the desired use of the tool 10.

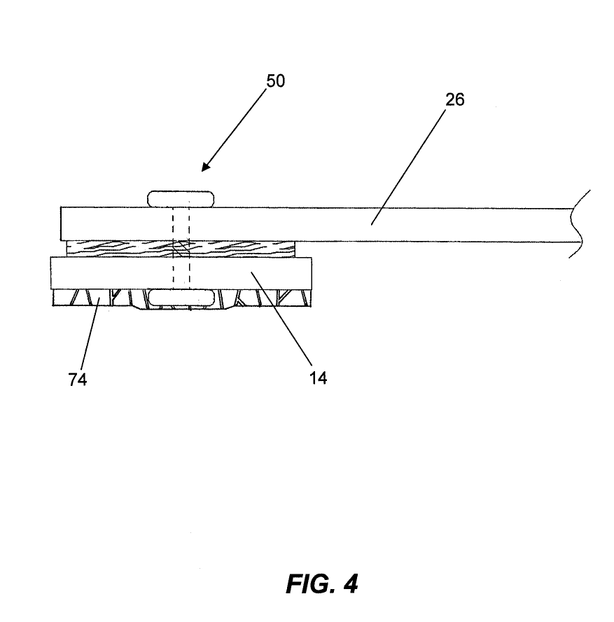

Turning now to FIG. 4, another end view of the base 14 is shown. A non-skid pad 74 is attached to the bottom of the base 14. The flange 66 (or pins) has been removed. The non-skid pad 74 makes the tool 10 easier to use where there is no grout line.

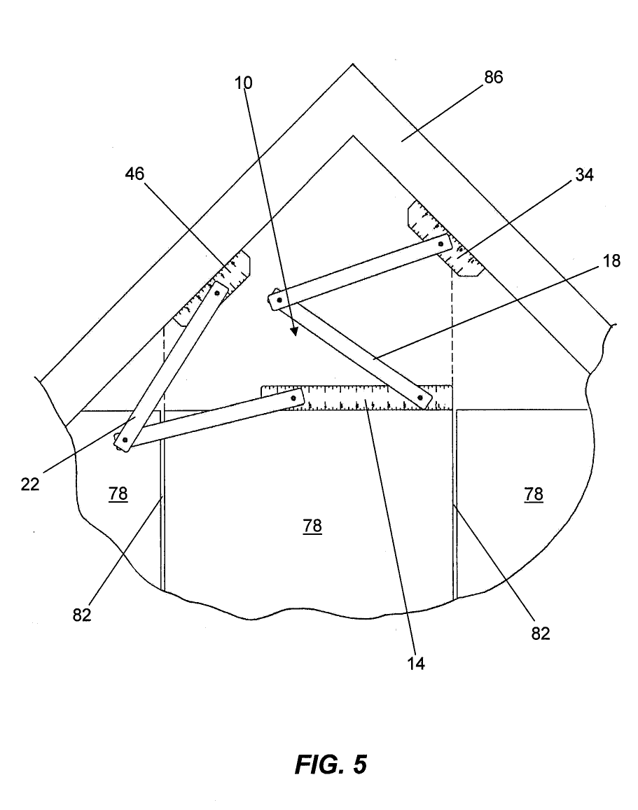

Turning now to FIG. 5, a top view of the tool 10 of the present invention is shown as may be used to measure the size and angles for cutting a piece of tile. Some tile 78 has already been set with a grout line 82. The base 14 is positioned by placing the outside edge of the flange 66 (or pins) against a piece of previously laid tile 78 such that the flange 66 is located where the next grout line will be. The base 14 may be placed adjacent a corner of the tile 78 to create a reference point of the position of the tool 10. The arms 18, 22 are placed such that the indicator members 34, 46 are placed in position where the next piece of tile is to be cut, such as against the wall 86. The indicator members 34, 46 may be placed tightly against the wall 86 if no gap is desired between the wall and the piece of tile being cut, or may be spaced out somewhat if a gap is desired. The indicator members 34, 46 may be spaced out simply by placing a grout spacer, stirring stick, pencil, etc. between the indicator members and the wall. Once the tool 10 is properly positioned, it is carefully removed from between the wall 86 and tile 78 so as to not move the indicator members 34, 46. As previously discussed, joints 50 which provide some resistance to movement are useful to keep the arms 18, 22 from moving when transferring the tool 10.

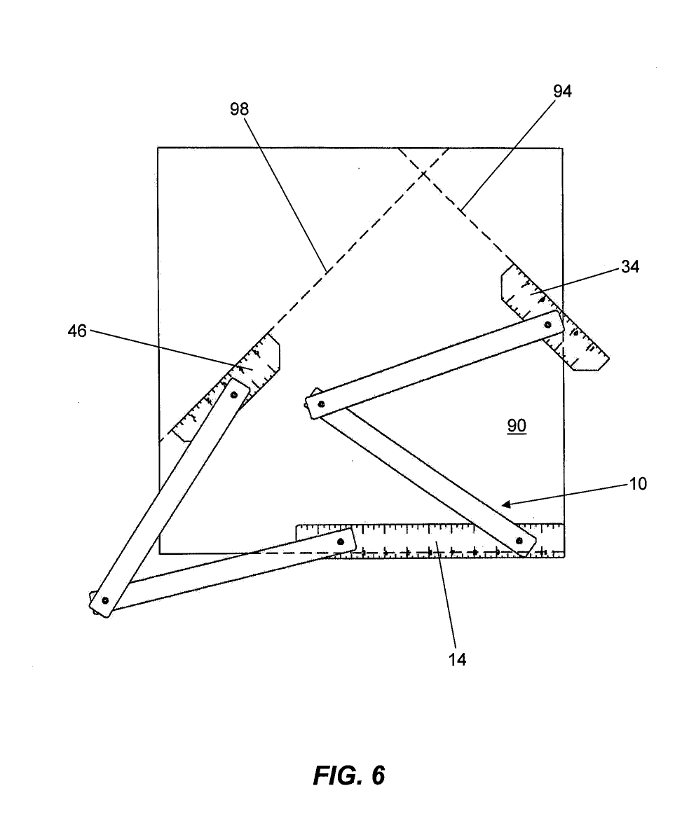

Turning now to FIG. 6, a top view of the tool 10 as is used to mark a piece of tile for cutting is shown. The tool 10 was set up as shown in FIG. 5 to determine the correct size and shape of the tile. The tool 10 is then transferred to a piece of tile 90. The base 14 is located by placing the inside edge of the flange 66 against the edge of the tile 90. Since the flange 66 occupies the grout line, the inside and outside edges of the flange represent the proper location of the tile edges surrounding the grout line. The right end of the base 14 is aligned with the right edge of the tile 90 since the tool 10 was aligned with the right edge of the adjacent tile during the setup procedure shown in FIG. 5. Once properly located, the tool 10 shows the proper cut lines 94, 98. The cut lines 94, 98 are indicated by the edges of the indicator members 34, 46. The cut lines 94, 98 are marked on the tile 90 and the tile is then cut using a conventional tile saw.

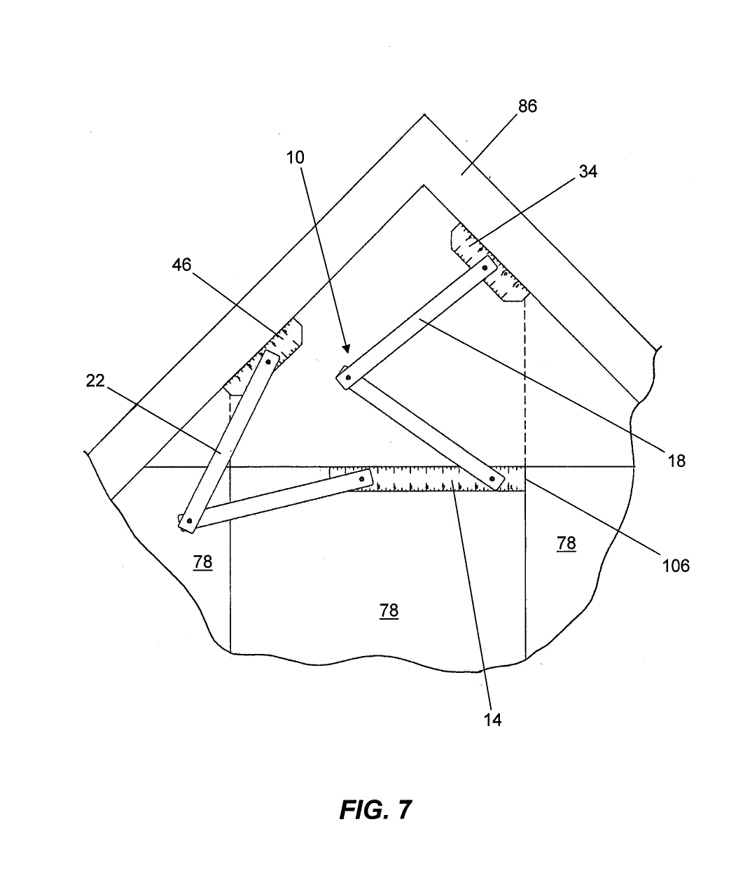

Turning now to FIG. 7, a top view of the tool 10 is shown as used to lay out tile without a grout line. The tool 10 is used substantially as described with reference to FIG. 5, except that no grout line is present between tiles 78. As such, the flange 66 (or pins) are removed from the base 14 or a tool 10 without a flange is used. The base 14 will typically include a non-slip surface as shown in FIG. 4 to allow for easier and more accurate layout of the tile. The base 14 is typically positioned by aligning it with the edge 102 and corner 106 of a tile 78 which has been previously installed. The indicator members 34, 46 are placed against the wall 86 or slightly away from the wall as discussed. When the tool 10 is properly positioned (as shown here), it is carefully lifted off of the floor and transferred to a piece of tile.

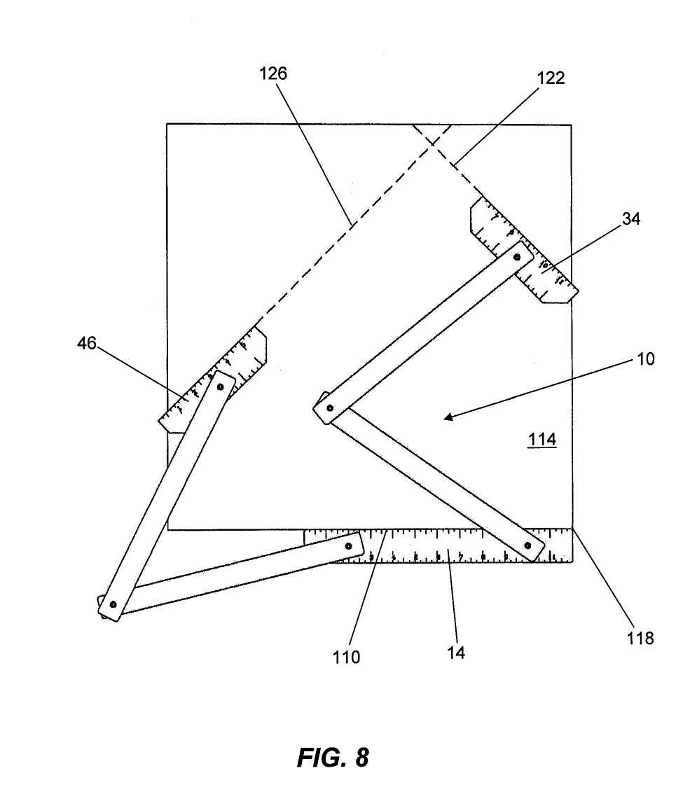

Turning now to FIG. 8 a top view of the tool 10 as used to mark a piece of tile for cutting is shown. After the setup procedure discussed with respect to FIG. 7, the tool 10 is carefully lifted off of the floor and placed on a piece of tile as shown. As the tool 10 was previously aligned with the edge and corner of tile 78, the base 14 is aligned by placing it against the edge 110 of tile 114 and aligning it with the corner 118 of the tile 114. Once the base 14 is properly aligned with the tile 114, the indicator members 34, 46 are lined up so as to indicate the cut lines 122, 126. Typically, the cut lines 122, 126 are marked on the tile 114, and the tile is then cut with a conventional tile saw.

It is appreciated from FIGS. 5 and 6 and FIGS. 7 and 8 that the tool 10 is used by creating the same relative alignment of the base 14 with the tile which is to be cut. When the tool is set up to determine the size and shape of the tile, the base is positioned against or on adjacent tiles where the base is in alignment with the desired location of the corresponding edge of the tile which is to be cut and installed. Then the tool 10 is carefully transferred to a tile for cutting. The base is aligned with the edge of this tile in the same relative orientation which was used to determine the shape and size of the tile. The non-slip layer 74 shown in FIG. 4 and the flange 66 or pins 68 shown in FIGS. 3A-3B aid in properly aligning and using the tool 10, making the tool easier and more accurate to use.

The tool 10 is especially easy to use. The joints 50 which provide some resistance to movement and which do not require any loosening, tightening, or other adjustment during use make it easy and quick to align the indicator members 34, 46. Additionally, the flange 66 or pins 68 allow for easy alignment of the tool 10 with previously installed material and with the material to be marked for cutting. The flange 66 or pins 68 allow for easy accommodation of a grout line or desired space between the pieces of material, and the spacers 70 allows for accommodation of varying sizes of grout lines or spaces.

The tool 10 preferably includes two arms 18, 22 and two indicator members 34, 46, allowing the tool to mark a wall or a corner of a wall in one step. While a third arm and third indicator member may be added, it may result in a tool which is more cumbersome when used. The tool 10 may be used to determine more complex shapes, such as a piece of tile which extends around a doorway or other protrusion in the wall. In such a situation, there may be three, four, five, or even more different lines which need to be cut. The tool 10 may thus be used sequentially to determine the location of and mark these different lines for cutting. For example, the base 14 of the tool 10 may be located against or on an previously installed tile and the indicator members 34, 46 placed against the wall or doorway to determine the position of a few of the wall and doorway edges. The tool 10 may then be transferred to a piece of tile and these edges marked on the tile. The tool may then be placed back against the installed tile and wall/doorway to locate the next edges, and these edges transferred to the tile. This is repeated until all necessary cuts are marked on the piece of tile. It is appreciated that this may still be significantly faster and more accurate than existing methods for marking tile for cutting the tile.

There is thus disclosed an improved tool for determining sizes and angles and cutting a piece of material to match the same. It will be appreciated that numerous changes may be made to the present invention without departing from the scope of the claims.

What is claimed is:

1. A tool for determining the shape of an opening and for transferring the shape to a material to be cut to fit the opening comprising:
a base;
a first indicator member;
a first arm, the first arm having a first end pivotably connected to the base and a second end pivotably connected to the first indicator member;
a second indicator member;
a second arm, the second arm having a first end pivotably connected to the base and a second end pivotably connected to the second indicator member; and
wherein the first and second indicator members are positionable

2. The tool of claim 1, wherein the first arm comprises a first arm section having a first end and a second end and a second arm section having a first end and a second end, and wherein the first end of the first arm section is pivotably connected to the base and the second end of the first arm section is pivotably connected to the first end of the second arm section, and wherein the second end of the second arm section is pivotably connected to the first indicator member; and
wherein the second arm comprises a first arm section having a first end and a second end and a second arm section having a first end and a second end, and wherein the first end of the first arm section is pivotably connected to the base and the second end of the first arm section is pivotably connected to the first end of the second arm section, and wherein the second end of the second arm section is pivotably connected to the second indicator member.

3. The tool of claim 2, wherein the pivotable joints provide resistance to movement.

4. The tool of claim 1, wherein the first arm and second arm are connected to the base adjacent the ends of the base.

5. The tool of claim 1, wherein the first and second indicator members are approximately six inches long.

6. The tool of claim 1, wherein the base is approximately 12 inches long.

7. The tool of claim 1, wherein the base has a ruler marked thereon.

8. The tool of claim 1, wherein the first and second indicator members have rulers marked thereon.

9. The tool of claim 1, wherein the base comprises a flange extending downwardly therefrom.

10. The tool of claim 7, further comprising a spacer configured for placement over the flange to thereby increase the width of the flange.

11. The tool of claim 1, wherein the tool is configured for determining the size and shape of an opening to thereby transfer said size and shape to a piece of material which is to be cut to fill the opening.

12. A tool for measuring and marking tile for installing tile around an obstacle comprising:
a base configured for placement adjacent an edge of an installed piece of tile;
a first indicator member having an edge;
a second indicator member having an edge;
a first arm having a first end and a second end, the first end being attached to the base and the second end being attached to the first indicator member, the first arm being movable to allow the positioning of the edge of the first indicator member adjacent an obstacle;
a second arm having a first end and a second end, the first end being attached to the base and the second end being attached to the second indicator member, the second arm being movable to allow the positioning of the edge of the second indicator member adjacent an obstacle.

13. The tool of claim 12, wherein the base has a flange extending from the bottom thereof, wherein the flange has a first side and a second side, and wherein the first side is configured for placement against an installed tile for measuring an opening and wherein the second side is configured for placement against a piece of tile which is to be cut so as to transfer the size and shape of the opening while maintaining a grout line equal to the width of the flange.

14. The tool of claim 12, wherein the base has a flange formed thereon for engaging a piece of tile to thereby align the tool.

15. The tool of claim 12, wherein the first arm and second arm pivot near the middle thereof.

16. The tool of claim 12, wherein the base has pins extending from the bottom thereof for aligning the base.

17. A method for providing a cut line in a mosaic element to thereby fit the mosaic element into an opening comprising:
selecting a tool comprising a base, a first indicator member, and a second indicator member, the first indicator member being attached to the base by a first arm so as to be movable relative to the base in a plane, and the second indicator member being attached to the base by a second arm so as to be movable relative to the base in said plane;
determining the size and shape of an opening by:
positioning the base in alignment with a first edge of the opening;
positioning the first indicator member such that an edge of the first indicator member is disposed in alignment with a second edge of said opening;
positioning the second indicator member such that an edge of the second indicator member is in alignment with a third edge of said opening;
transferring the size and shape of the opening to a piece of material which is to be cut to fill the opening by:
placing the tool adjacent the piece of material;
aligning the base of the tool to an edge of the piece of material which corresponds to the first edge of the opening;
marking the piece of material in alignment with the edge of the first indicator member so as to make a mark corresponding with the second edge of the opening; and
marking the piece of material in alignment with the edge of the second indicator member so as to make a mark corresponding with the third edge of the opening.

18. The method of claim 17, wherein the method further comprises selecting a tool having a flange extending from the bottom of the base, and wherein the method comprises placing a first side of the flange adjacent the first edge of the opening while determining the size and shape of the opening and wherein the method comprises placing a second side of the flange against the edge of the piece of material while transferring the size and shape of the opening to the piece of material to thereby provide for a space between the edge of the piece of material and the first edge of the opening.
